(19) United States
(12) Patent Application Publication
(10) Pub. No.: US 2008/0283661 A1
(43) Pub. Date: Nov. 20, 2008

(54) Remote Controlled Mobile Platform

(76) Inventor: Bruce Hyndman Henley, Invercargill (NZ)

Correspondence Address: JOHN ALEXANDER GALBREATH, 2516 CHESTNUT WOODS CT, REISTERSTOWN, MD, 21136, US

(21) Appl. No.: 12/092,078

(22) PCT Filed: Jul. 30, 2007
(86) PCT No.: PCT/NZ07/00198

§ 371 Date: Apr. 30, 2008

(30) Foreign Application Priority Data
Aug. 2, 2006 (NZ) 548910
Aug. 24, 2006 (NZ) 549435

(51) Int. Cl. B64F 1/00

(52) U.S. Cl. 244/114 R

(57) ABSTRACT

A self-powered mobile platform that is configured to be remotely wirelessly controlled, said platform including a base with a first face that is dimensioned and configured to allow a vertical landing aircraft to land and take off.

### FIELD OF THE INVENTION

The present invention is a remotely controlled mobile platform for carrying items, in particular for carrying small vertical take off and landing aircraft such as helicopters. The present invention is especially useful for helicopters, and will be described with particular reference to that application. However it will be appreciated that the platform of the present invention can also be used for other vertical take off and landing aircraft.

### BACKGROUND

When a helicopter lands at its destination the pilot lands and shuts it down. Once shut down the helicopter often needs to be moved to where it is to be stored or parked, which may be inside a hangar. With the helicopter shut down it cannot now be moved under its own motive power and this has led to a number of solutions, each with their-own limitations.

One of the simplest devices used to move helicopters are jockey wheels which may be permanently attached to the helicopter, or stored separately and inserted into sockets on the helicopter. Either way, the pilot needs to exit the helicopter, or ground crew needs to arrive, and fit or move the jockey wheels into place so that the helicopter can be moved. If the helicopter is light enough it can then be manually rolled into the required position and the jockey wheels removed or repositioned to prevent the helicopter moving.

If the helicopter is unable to be moved manually then, once the jockey wheels are in position, a trolley jack may be necessary. The trolley jack is being used to elevate the helicopter so that it can be pushed or pulled into the required position. A trolley jack can also be used alone without jockey wheels, jacking the helicopter up and supporting it while it is moved to the required location. To move the helicopter the trolley jack needs to be retrieved from its storage position and then returned.

Some helicopters are also moved from the apron using a tow cart; this once again needs to be retrieved from storage and then returned after use.

The jockey wheels, trolley jack and tow cart are generally un-powered devices so the helicopter supported by these is often manually pushed or pulled around. If the weather is inclement or the environment is dusty this can be an unpleasant job. In addition if the apron where the helicopter has landed is not in good condition one person may not be able to successfully move the helicopter.

This has led to the use of tow trolleys pulled by tow tractors:—the helicopter upon arrival lands on the apron and is shut down, the tow trolley is brought out and the helicopter is then started and lifts off to land on the tow trolley. The helicopter on the tow trolley is then moved to the desired location, and the tow tractor returned to its storage area. The tow trolley has to be moved within a hangar in amongst other aircraft by the tow tractor; this requires a great deal of care and often involves backing the tow trolley into place. Backing the tow trolley with the helicopter into place can be a slow process as it is difficult to estimate the position of the boom and blades. If the pilot has no ground crew then the pilot will be using the tow tractor to store the helicopter on the tow trolley. A pilot of a helicopter generally knows the dimensions of their helicopter intimately when in the cockpit, but on the tow tractor the pilot has the same problems estimating the length as anyone else.

In general there is no ground crew available to move or attach the above devices to the helicopter upon arrival, thus either a passenger or the pilot must do this. The steps required to store the helicopter in the hangar then become:
a. Land on apron, shut helicopter down and make safe.
b. The passenger or pilot exits the helicopter and retrieves the device to be used to move the helicopter.
c. The device is attached to or elevates the helicopter which is then moved. If a tow trolley is used the helicopter is started, lifts off and lands on the tow trolley, then shut down and is made safe, then moved.
d. The helicopter attached to the device is then maneuvered inside the hangar into the desired position.

If conditions are inclement the storing of the helicopter in a hangar can be an unpleasant experience. In addition the time required to retrieve the required equipment from the storage locations, make the helicopter ready to move, move the helicopter and return the equipment, can make the job arduous.

Often the helicopter needs to be stored inside a hangar which requires maneuvering the helicopter within the confined area of the hangar, often with other aircraft and obstacles present. Any difficulty in using the device supporting the helicopter increases the chance it could be damaged or that the storage space inside the hangar is inefficiently used. At the very least, storing the helicopter can become a time consuming exercise.

The jockey wheels and trolley jack require that the user physically moves the helicopter. The tow jack can be directly connected to a tow trolley, and though some self powered tow trolleys are known, these require that the user exit the helicopter to use the trolley, for example one self powered device requires the use of a control panel wired into the tow trolley. Thus all of the known devices require that the pilot, passenger or ground crew is outside the helicopter.

When a helicopter lands or takes off it needs to be aligned optimally for the prevailing wind conditions.

The weight and balance of an aircraft can affect the handling and safety of that aircraft. It is difficult to determine the weight and balance of a helicopter thus at times the handling and safety of that helicopter can be adversely affected. The weight and balance information is different for each helicopter thus at present any devices that require this information need to have it manually entered.

### OBJECTS OF THE INVENTION

An object of the present invention is to provide a mobile platform that meets one or more of the following objectives:
1. Provide a platform that reduces the time taken to store an aircraft;
2. Provide a platform that can be easily moved within a hangar or similar confined space;
3. Reduce or remove the need for a person to be outside an aircraft being transported on the platform;
4. Provide a useful and economic choice.
5. Provide a platform that can automatically and optimally align itself for the prevailing wind conditions at the time;
6. Provide a platform that can measure the weight and balance of an aircraft on it;
7. Provide a platform that can adjust the position of an aircraft on the platform without manual intervention;
8. Provide means for automatically determining the type of aircraft landing.

### DISCLOSURE OF THE INVENTION

The present invention provides a self-powered mobile platform that is configured to be remotely wirelessly controlled, said platform including a base with a first face that is dimensioned and configured to allow a vertical landing aircraft to land and take off.

In a preferred form the first face is a rectangular planar surface.

Preferably the aircraft is a helicopter.

Preferably the mobile platform is controlled by a person inside the aircraft.

Preferably the base includes movement means adapted to move the platform across the ground. Preferably said movement means are one or more pairs of drive units, the or each pair of drive units extending from or through a second face which is opposite the first face. In a highly preferred form the or each pair of drive units is configured to swivel about an axis perpendicular to the first face. Preferably these drive units are wheels, groups of wheels or short self laying tracks. Alternatively said movement means are two or more independently driven omni-directional wheels, each omni directional wheel extending from or through the second face which is opposite the first face. In a highly preferred form there are four omnidirectional wheels.

In a highly preferred form each drive unit or omni-directional wheel is driven by a motive device. Preferably the motive device for each drive unit or omni-directional wheel is located in its hub. Preferably the motive device is selected from the list consisting of an electric motor, a hydraulic motor and an air driven motor.

Preferably the platform includes a receiver configured to receive a wireless signal and a control unit configured to individually control the or each omni-directional wheel or drive unit, such that the wireless signal received by the receiver is passed to the control unit in a form which it understands. Preferably the receiver and control unit are a single device.

Preferably the control unit includes stored preset movement patterns, such that a single wireless signal causes a preset pattern of movements to be undertaken by the platform. In a highly preferred form one the preset pattern of movements causes the platform to return to its storage location. Preferably the stored preset movement patterns are modified by input from external devices such as a gps or obstacle avoidance unit.

Preferably the control unit is configured to receive a weather signal from a weather station. Preferably the control unit is configured to adjust the position of the platform based on that weather signal by activating one or more of the drive units or omni-directional wheels. In a highly preferred form the control unit is adapted to adjust the position of the platform into the wind. Preferably the control unit is configured to receive information from a Global Positioning System (GPS) device and combine this with the weather signal from the weather station to adjust the position of the platform. Preferably the weather signal includes wind velocity and direction information, barometric pressure, temperature and humidity.

Preferably the platform includes one or more supports configured to stabilise the platform. In a preferred form there are four spaced supports located close to the peripheral edge of the base. In a highly preferred form these supports are castors configured to swivel about an axis perpendicular to the first face.

Preferably each pair of drive units consists of a primary drive unit adjacent to a secondary drive unit, such that each drive unit is configured to be individually driven. In a highly preferred form there is a first pair of drive units and a second pair of drive units. In a still further preferred form the first pair of drive units is located midway along a first side of the base and the second pair of drive units is located midway along a second side; the first and second sides being adjacent the first face and opposite each other.

Where the platform includes pairs of drive units the platform can be moved forward by driving all of the pairs of drive units in the same direction at the same speed.

When there is a first and second drive unit the platform can be turned in an arc by driving the first pair of drive units at a different rate to the second pair of drive units.

When there is a first and second drive unit the platform can be turned about an axis perpendicular to the first face by driving the first pair of drive units at the same speed as, but in the opposite direction to, the second pair of drive units.

The platform, where it includes drive units, can be moved sideways, i.e. perpendicular to the sides by undertaking the following steps in order:
a. The primary drive units are driven in the opposite direction to the secondary units such that each pair of drive units swivels about their perpendicular axis;
b. when the direction of travel of each drive unit is perpendicular to the sides, the drive units are stopped;
c. the drive units are all then driven in the same direction.

When there is a first and second drive unit the platform can be slewed by undertaking the following steps in order:
d. The first pair of drive units is driven in the opposite direction to the second pair of drive units, such that the platform swivels about an axis perpendicular to the first face;
e. When the axis direction of travel of each drive unit is aligned to the required slew direction, the drive units are stopped;
f. the drive units are all then driven in the same direction.

Preferably the or each drive unit or omni-directional wheel includes a traction control device.

Preferably the first face includes at least two landing strips, such that each strip is dimensioned and configured to accommodate one skid or wheel of the aircraft on the platform.

Preferably the platform includes a load unit and at least one load measuring device.

Preferably, where present, the or each support includes a load measuring device, the or each said load measuring device is configured to measure the load on the associated support and generate a measured load signal then transmit this to the load unit.

Preferably, where present, the or each landing strip includes at least one load measuring device. The or each said load measuring device is configured to measure the load on all or part of the associated landing strip and generate a measured load signal then transmit this to the load unit. Preferably the load unit combines these measured load signals to calculate a landing strip signal related to the associated landing strip.

In a highly preferred form the load measuring device is a load cell. It is further preferred that the load unit combines the measured load signal from the or each load measuring device to create a platform load signal. It is preferred that the load unit is configured to further process the platform load signal to create an aircraft load signal representative of the weight and balance of the aircraft on the platform. In a highly preferred form this platform load signal and/or aircraft load signal is transmitted to a visual display unit which is configured to display the weight and balance of the platform or aircraft. In a highly preferred form the platform load signal and/or aircraft load signal are continuously updated and transmitted. In a further highly preferred form the weather data is combined with aircraft information and the platform and/or object load signal to calculate a maximum hover altitude for the aircraft.

Preferably the platform includes a moving device; said moving device is configured to adjust the position and orientation of the aircraft on the platform into a desired position. In a highly preferred form the moving device is configured to be controlled by a control signal from the load unit or control unit. In a preferred form the control unit or load unit is configured to use the measured load signal from the or each load measuring device and weight and balance data for the aircraft to create the control signal.

In a preferred form the aircraft includes a transponder that is configured to store and transmit aircraft data; said aircraft data is data relating to the aircraft. In a highly preferred form the aircraft data is one or more pieces of information selected from the group consisting of weight and balance data, identification data, performance data or similar.

Preferably the first face includes self illuminating patterns. Preferably the self illuminating patterns are self luminescent. In a highly preferred form these patterns provide a graphical representation of the orientation of the platform. It is further preferred that these patterns are visible to a user in the aircraft landing on the mobile platform at night.

The present invention also includes a storage system for storing a vertical landing aircraft with skids, said storage system includes a mobile platform with two landing strips and one or more storage bays; each landing strip includes a platform channel that extends lengthwise to at least one end of the first face, each said platform channel includes a plurality of platform rollers, said storage bay includes a pair of bay channels that include a plurality of bay rollers, each channel is a unshaped channel and each platform roller is a cylindrical roller with it's rotational axis perpendicular to the length of the associated channel, such that the rollers are configured to support the aircraft on the platform or stored in the bay.

Preferably at least one platform roller in each platform channel is independently driven by a platform motive device. Preferably said platform motive device is chosen from an electric motor, a hydraulic motor and a pneumatic motor. In a highly preferred form at least one bay roller is driven by a bay motive device. Preferably said bay motive device is chosen from an electric motor, a hydraulic motor and a pneumatic motor. In a highly preferred form two or more platform rollers form part of the moving device.

The present invention also includes a method for storing aircraft using the storage system that includes the following steps, in order:
i. The aircraft lands on the mobile platform with each skid supported by the platform rollers of a separate platform channel;
ii. The alignment of the aircraft is adjusted so that its longitudinal axis is parallel to the longitudinal axis of the platform channels;
iii. The mobile platform transports the aircraft to the storage bay desired;
iv. The position of the mobile platform is adjusted so that the longitudinal axis of each platform channel aligns with the longitudinal axis of a matching bay channel of the storage bay;
v. The mobile platform is moved towards the storage bay until each bay channel and the matching platform channel form a single continuous path for the aircraft to follow;
vi. The helicopter is then moved along the platform rollers and onto the bay rollers, until the aircraft is properly stowed in the storage bay.

### DESCRIPTION OF THE DRAWINGS

By way of example only a specific embodiment of the present invention will now be described in detail with reference to the accompanying drawings in which:

FIG. 1 is a side elevation of the mobile platform with a helicopter supported.

FIG. 1a is a side elevation of the mobile platform with a helicopter supported with a load unit mounted on the platform.

FIG. 2 is a bottom view of the platform with the wheels aligned for forward motion.

FIG. 3 is a bottom view with the wheels aligned for sideways motion.

FIG. 4 is a side elevation of the second embodiment of the mobile platform with building and weather station shown.

FIG. 5 is a bottom view of the fourth embodiment of the mobile platform with the wheels aligned for forward motion with load cells attached to each of the castors.

FIG. 6 is a plan view of the transmitter.

FIG. 7. is a front elevation view of a mecanum omnidirectional wheel of known type.

FIG. 8. is a bottom view of the fifth embodiment of the mobile platform incorporating mecanum (omni-directional) wheels.

FIG. 9. is top view of the sixth embodiment of the mobile platform.

FIG. 10. is a top view of the seventh embodiment of the mobile platform abutted against a storage bay.

FIG. 11. is a side elevation of the seventh embodiment of the mobile platform, supporting a helicopter, abutted against a storage bay.

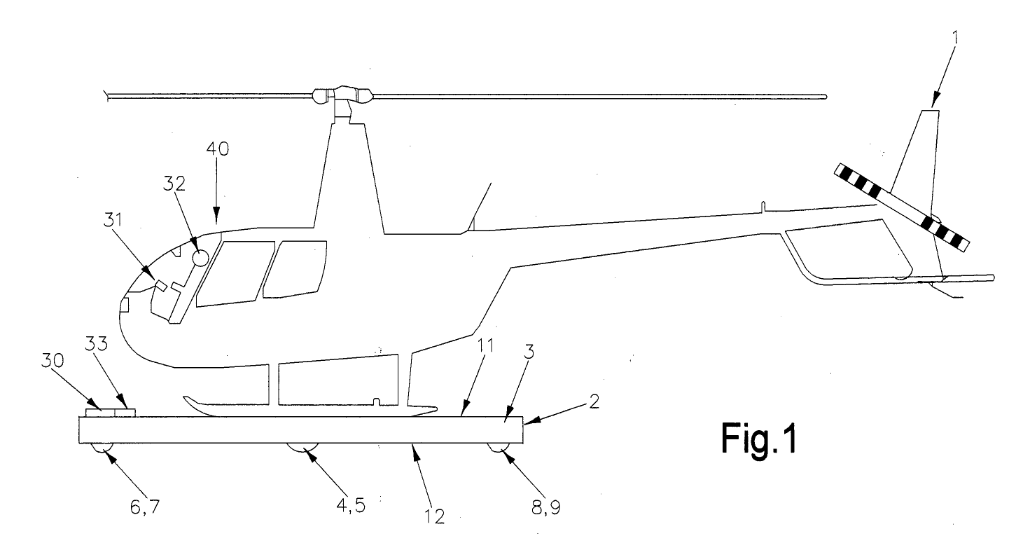

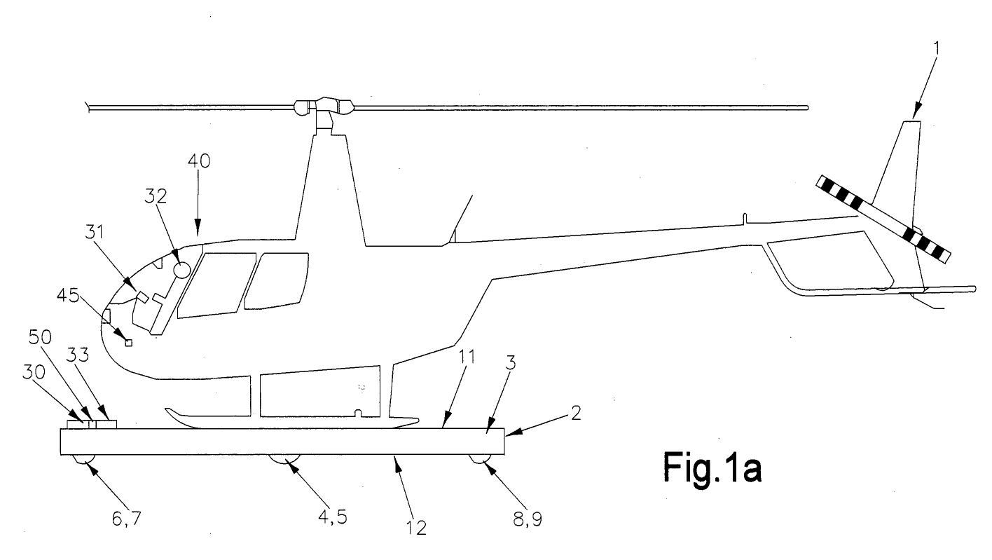

Referring to FIG. 1 a helicopter (1) is shown supported by a mobile platform (2).

Said mobile platform (2) includes a base (3), a first pair of drive wheels (4), a second pair of drive wheels (5) and four castors (6,7,8,9). Said base (3) is a rectangular prism with the height much less than the width or length.

The base (3) includes a first face (11), a second face (12), a first side (13) and a second side (14). The first face (11) is a rectangular flat plane adapted and dimensioned to allow the helicopter (1) to land and take off from it; the second face (12) is opposite the first face (11). The first and second sides (13,14) are adjacent both faces (11,12) and opposite each other.

The castors (6,7,8,9) and pairs of drive wheels (4,5) extend from, or through, the second face (12) to the ground and are adapted to support the base (3). Each of the castors (6,7,8,9) is of a standard type and adapted to swivel about an axis perpendicular to the first face (11) thus align with the direction the mobile platform (2) is moving. Each castor (6,7,8,9) is located close to a corner (16,17,18,19) of the base (3) inside the peripheral edge of said base (3).

The first pair of drive wheels (4) is inset from the peripheral edge of the second face (12) mid-way along the first side (13). The second pair of drive wheels (5) is inset from the peripheral edge of the second face (12) mid-way along the second side (14). Each pair of drive wheels (4,5) is adapted to swivel about an axis perpendicular to the first face (11).

The first pair of drive wheels (4) consists of a primary first wheel (20) adjacent to a secondary first wheel (21), and the second pair of drive wheels (5) consists of a primary second wheel (22) adjacent to a secondary second wheel (23). Each of the wheels (20,21,22,23) is adapted to be separately reversibly driven by a small electric motor located in its hub.

The mobile platform (2) includes a receiver (30) adapted to receive a wireless signal from a transmitter (31) which is adapted to take input from a user (32) and convert this into the wireless signal. Said receiver (30) is connected to a control unit (33) which is adapted to control the or each wheel (20,21,22,23) independently and move the platform (2) in the direction required by the user (32). The wireless signals can be optical, radio frequency or similar. The user (32) does not need to leave the cockpit (40) of the helicopter (1) and thus avoids exiting the helicopter (1) to control the platform (2). The user (32) can also control the platform (2) from outside, i.e. remotely from, the helicopter (1) using the transmitter (31).

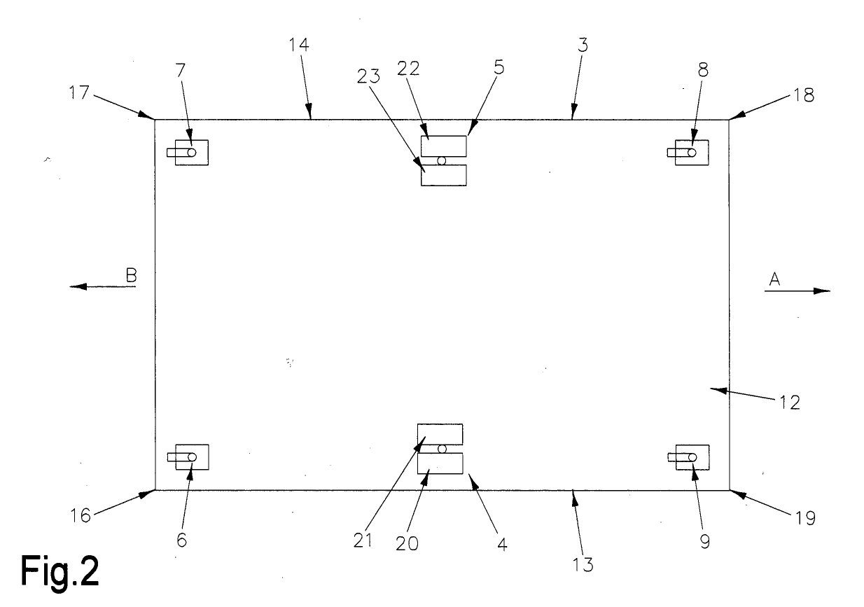

To move the platform (2) in the direction of arrows A or B (FIG. 2), i.e. parallel to the sides (13,14), all of the wheels (20,21,22,23) are driven in the same direction at the same speed. To cause the platform (2) to turn in an arc one pair of drive wheels (4,5) is driven at a different rate to the other pair of drive wheels (4,5).

To turn the platform (2) about an axis perpendicular to the first face (11) the first pair of drive wheels (4) is driven at the same speed as, but in the opposite direction to, the second pair of drive wheels (5).

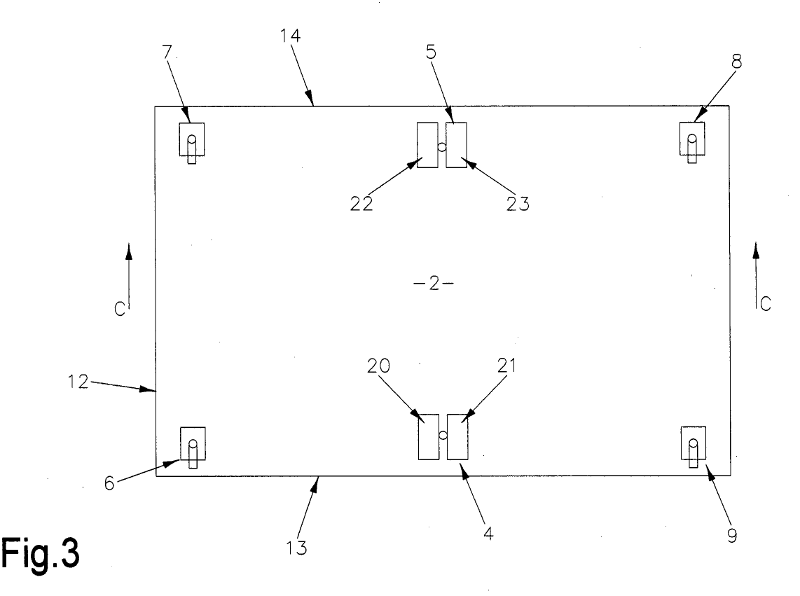

To move the platform (2) sideways, ie perpendicular to the sides (13,14), the following steps are undertaken in order:
g. The primary wheels (20,22) are driven in the opposite direction to the secondary wheels (21,23). This causes each pair of drive wheels (4,5) to swivel about an axis perpendicular to the first face (11).
h. When the axis about which each wheel (20,21,22,23) rotates is parallel to the sides (13,14), the wheels (20,21,22,23) are stopped;
i. The wheels (20,21,22,23) are all then driven in the same direction. (Arrow C of FIG. 3).

To slew the platform (2) the following steps are undertaken in order:
j. The first pair of drive wheels (4) is driven in the opposite direction to the second pair of drive wheels (5). This causes the platform (2) to swivel about an axis perpendicular to the first face (11).
k. When the axis about which each wheel (20,21,22,23) rotates is perpendicular to the required slew direction the wheels (20,21,22,23) are stopped;
l. The wheels (20,21,22,23) are all then driven in the same direction.

In a further embodiment (not shown) each of the wheels (20,21,22,23) is replaced by a short self laying track unit.

In a further embodiment (not shown) each wheel (20,21,22,23) is replaced by three rollers, one roller located at each apex of an equilateral triangle, such that two rollers are in contact with the ground at any given time. This embodiment allows the platform (2) to pass over a small dip or channel and maintain drive.

In a further preferred embodiment (not shown) the or each castor (6,7,8,9) is replaced by a skid or a ski.

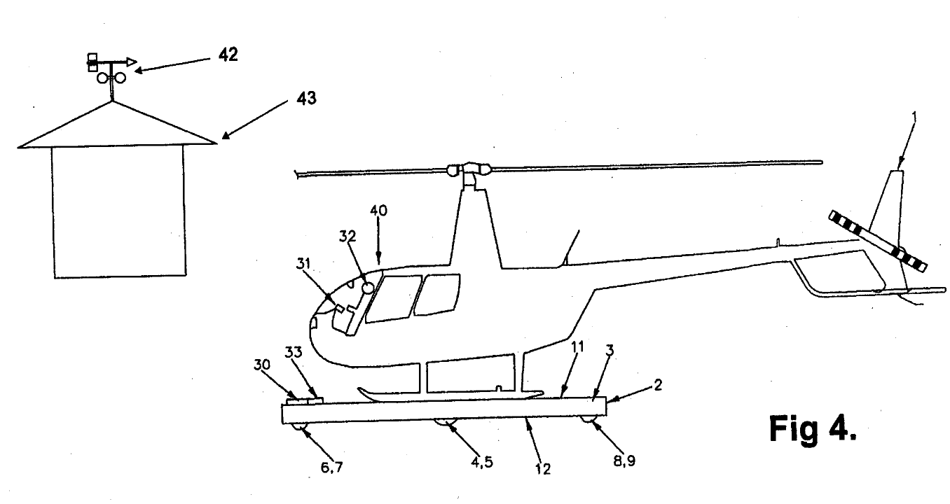

Referring to FIG. 4 a second embodiment is shown where the helicopter (1) is supported by the mobile platform (2) in proximity to a weather station (42) located on a building (43). The weather station (42) is of a standard type, said weather station (42) wirelessly transmits a weather signal representative of the wind conditions, including velocity and direction. The receiver (30) is adapted to receive this weather signal and transmit it to the control unit (33). When the user (32) wishes the mobile platform (2) to face into the wind they use the transmitter (31) to transmit a wireless into-wind signal to the control unit (33). Upon receiving the into-wind signal the control unit (33) is adapted to control the or each wheel (20,21,22,23) independently and move the mobile platform (2) in the direction required to align said mobile platform (2) into the wind. This into-wind adjustment does not move the mobile platform (2) significantly from its apron position:—it only aligns the mobile platform (2) optimally for landing and take-off based on weather conditions.

In a third embodiment (FIG. 6) the transmitter (31) includes a transponder (44) which is adapted to store, and when requested to transmit, data pertaining to the helicopter (1) to the receiver (30) which then passes it on to the load unit (50) and/or control unit (33). The data includes weight and balance information, but may include type, maintenance records or other information.

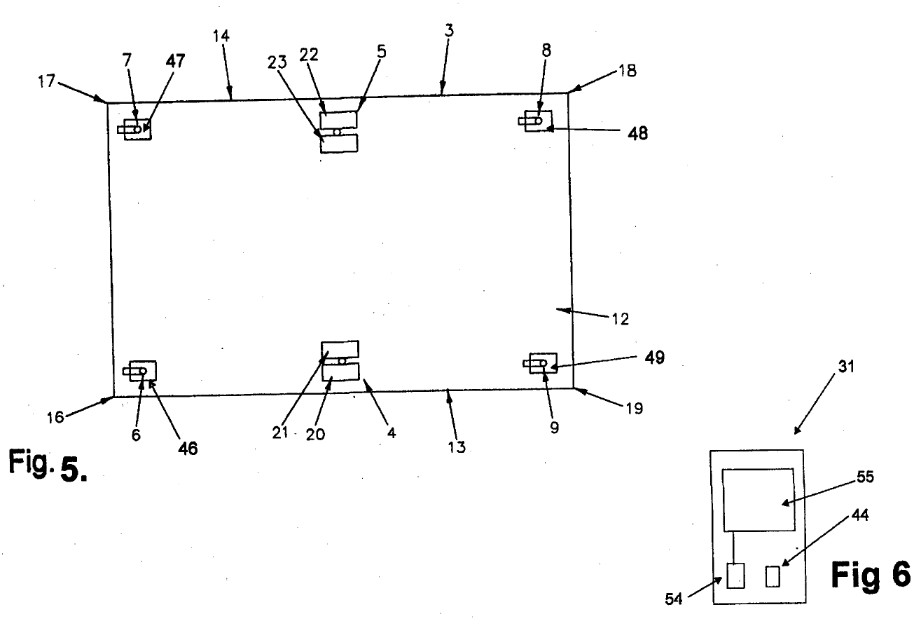

Referring to FIGS. 1a and 5 a fourth embodiment of the mobile platform (2) is shown; in this embodiment each of the castors (6,7,8,9) includes a load cell (46,47,48,49) of a known type. Each load cell (46,47,48,49) is adapted to measure the load on the respective castor (6,7,8,9) and generate, then transmit to a load unit (50), a castor load signal based on this load. The load unit (50) is adapted to combine the castor load signal from each of the load cells (46,47,48,49) with pre-entered data relating to the helicopter (1) and generate a load distribution signal. In this embodiment the transmitter (31) as shown in FIG. 6 includes a second receiver (54) and a display panel (55). The second receiver (54) is adapted receive the load distribution signal and display it on the display panel (55) of known type for the user (32). The user (32) can then see how the load is distributed on the mobile platform (2) and thus the weight and balance of the helicopter (1). This load distribution signal can be used to dynamically update the display panel (55) as the helicopter (1) is loaded and allow the user (32) to adjust this as needed. The transmitter (31) can be a purpose built device, a Personal Digital Assistant (PDA), laptop, notebook or similar device. The load unit (50) is adapted to generate and store tare values for the or each of the following:
A. the load on each castor (6,7,8,9) for the mobile platform alone;
B. the load on each castor (6,7,8,9) with the helicopter (1) optimally located but unloaded on the mobile platform (2);

The mobile platform (2) includes a moving device (not shown); said moving device is adapted to move the helicopter (1) on the mobile platform (2). The moving device is configured to be controlled by the load unit (50) and to position the helicopter (1) in the optimum position on the mobile platform (2). The load unit (50) is adapted to use the transponder (44) data or manually entered data pertaining to the weight and balance of the helicopter (1) and the load distribution signal to control the moving device. The moving device can include small moveable platforms, scrolling and rolling conveying means or similar.

In a further embodiment the control unit (33) is adapted to accept a GPS (Global Positioning System Device) signal from a GPS (not shown) and combine this with the weather station (42) signal to adjust the position of the platform (2). The Control Unit (33) in this embodiment includes an adjustment table (not shown) which is a list of correction factors that take into account the way the wind at the mobile platform's (2) location is modified by buildings and other objects.

In a still further embodiment the weather station (42) is adapted to transmit more detailed weather information to the control unit (33), this information may include temperature, humidity, barometric pressure and the variability of this data over time.

In a still further embodiment (not shown) the control unit (33) is connected to a second transmitter that transmits data to the second receiver (54) for display on the display panel (55).

In a further embodiment an updatable RFID (Radio Frequency IDentification) tag (45) or similar is attached to the helicopter (1) and is used instead of the transponder (44) to directly transmit the data when queried.

In a still further embodiment the RFID tag (45) or transponder (44) is encrypted and is adapted to transmit the data only when it receives a correctly coded access signal.

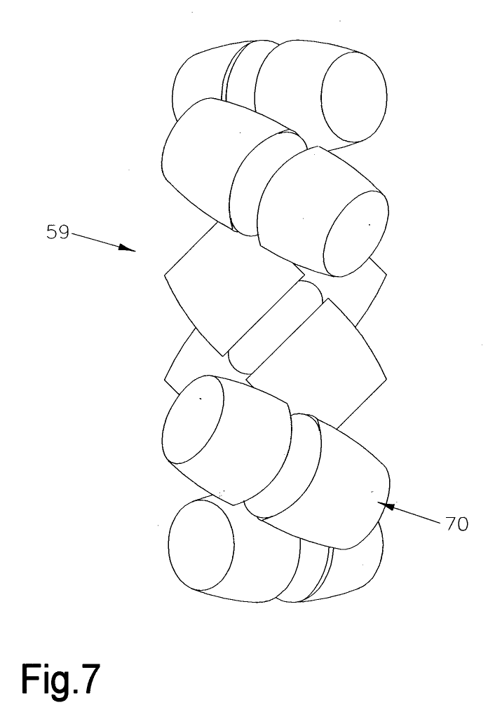

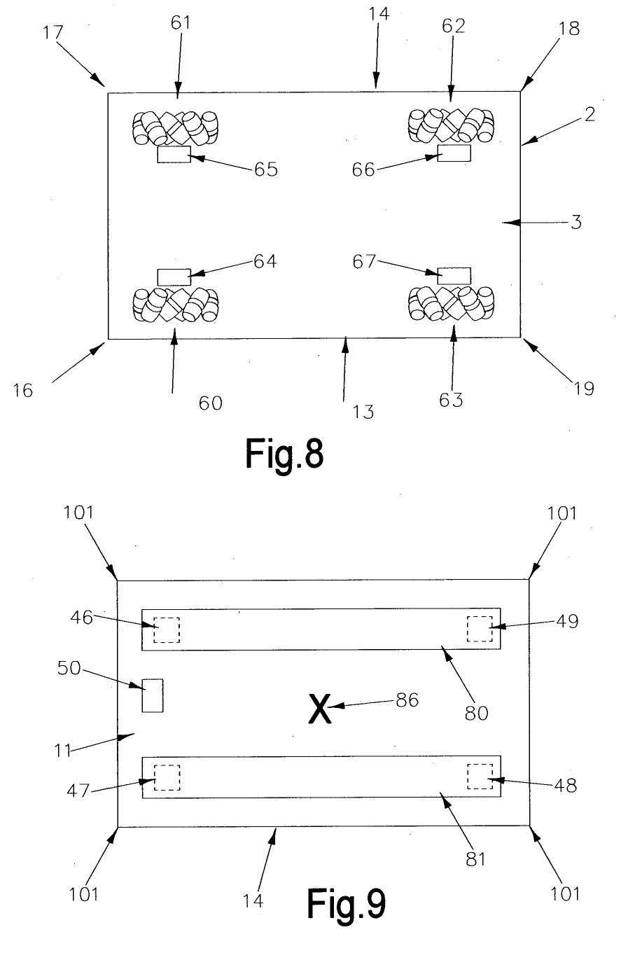

Referring to FIGS. 7 and 8 a mecanum wheel (59) of known type, and a fifth embodiment of the mobile platform (2) respectively, are shown. The mecanum wheel (59) is an omni-directional wheel such as that described in U.S. Pat. No. 3,875,255 (lion) which incorporates rollers (70) around its periphery.

The fifth embodiment of the mobile platform (2) includes four omni-directional wheels (60,61,62,63), for brevity these will be referred to as OD wheels. Each OD wheel (60,61,62,63) extends from, or through, the second face (12) to the ground and is adapted to support the base (3).

Each OD wheel (60,61,62,63) is located close to, but inset from, a separate corner (16,17,18,19) of the base (3). Each of the OD wheels (60,61,62,63) is independently driven by an electric or hydraulic motor (64,65,66,67). By varying the speed and direction that each OD wheel (60,61,62,63) is driven the mobile platform (2) can be moved, rotated or slewed in any direction. The exact operation of each OD wheel (60,61,62,63) to cause the mobile platform (2) to move in a desired way is described, for example, in U.S. Pat. No. 3,746,112.

Referring to FIG. 9 a sixth embodiment of the mobile platform (2) is shown. In this embodiment the mobile platform includes two landing strips (80,81) in the first face (11). Each of the landing strips (80,81) is a separate rectangular strip with a length much greater than the width. Lengthwise each landing strip (80,81) lies parallel to the sides (13,14) of the mobile platform (2). The landing strips (80,81) are dimensioned and spaced apart to match the length and spacing of the skids (or wheels) of a helicopter (1) (not shown in FIG. 9); such that a helicopter (1) can land on the landing strips (80,81). Each landing strip (80,81) includes load cells (46,47,48,49) located close to each end, of each landing strip (80,81). Each load cell (46,47,48,49) is configured to measure the load on that end of the landing strip (80,81) and transmit this to the load unit (50). The load unit (50) is adapted to combine the load signal from each of the load cells (46,47,48,49) with pre-entered data relating to the helicopter (1) and generate a load and load distribution signal. The load distribution signal can be displayed on the mobile platform (2) or one of the following: a purpose built device, a Personal Digital Assistant (PDA), laptop, notebook or similar device. The load information can be used as described in the fourth embodiment, that is to allow a pilot to optimally distribute the load of the helicopter (1).

For embodiments with load cells (46,47,48,49) the load and load distribution can be measured dynamically then combined with the measured temperature, barometric pressure and helicopter (1) information to calculate maximum hover altitude in real time. This can provide additional safety information to the pilot as the helicopter (1) is loaded. In addition by measuring the take-off load and load balance at the start of a journey and the load and load balance at the end of the journey the fuel used and any shift in load distribution can be measured.

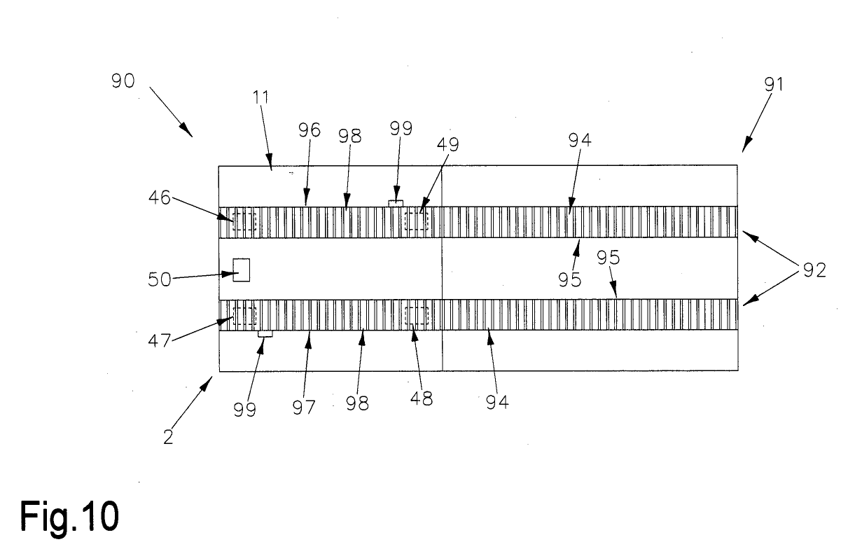

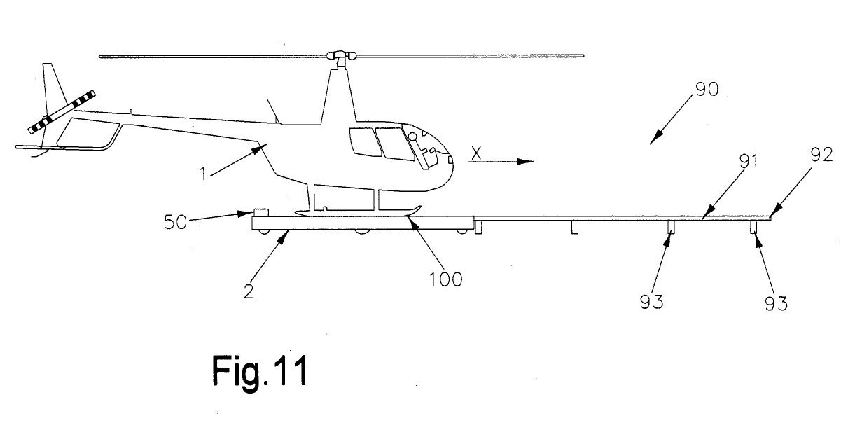

Referring to FIGS. 10 and 11 a seventh embodiment of the mobile platform (2) is shown as part of a system (90) for storing the helicopter (1). The system (90) includes the mobile platform (2) and one or more storage bays (91).

Each storage bay (91) includes two bay channels (92) supported by one or more support pillars (93). Each of the bay channels (92) includes a plurality of bay rollers (94) that are configured, in use, to support the helicopter (1). The rotational axis of each bay roller (94) is perpendicular to a primary side (95) of the respective channel (92).

In the seventh embodiment each of the landing strips (80,81) described in the sixth embodiment are replaced with a platform channel (96,97) each extending lengthwise to the periphery of the first face (11). Each platform channel (96,97) includes a plurality of platform rollers (98). The rotational axis of each platform roller (98) lies perpendicular to the side (13,14) of the mobile platform (2). Each platform channel (96,97) is supported on load cells (46,47,48,49) so that the load and load distribution on each platform channel can be measured.

Each of the rollers (94,98) is an essentially cylindrical roller of known type, either solid or hollow. The surface of the rollers (94,98) may be configured to grip the surface of the skid in contact with it.

One method of using the system (91) includes the following steps, in order:
i. The helicopter (1) lands on the mobile platform (2) with each skid (100) supported by the platform rollers (98) of a separate platform channel (96,97);
ii. The alignment of the helicopter (1) is adjusted so that its longitudinal axis is parallel to the longitudinal axis of the platform channels (96,97);
iii. The mobile platform (2) carries the helicopter (1) to the storage bay (91) desired;
iv. The position of the mobile platform is adjusted so that the longitudinal axis of each platform channel (96,97) aligns with the longitudinal axis of a respective bay channel (92) of the storage bay (91);
v. The mobile platform (2) is moved towards the storage bay (91) until each bay channel (92) and the respective platform channel (96,97) form a single continuous path for the helicopter (1) to follow;
vi. The helicopter is then moved along the platform rollers (98) and onto the bay rollers (94), until the helicopter (1) is properly stowed in the storage bay (91);

The height above ground of the platform rollers (98) and bay rollers (94) is such that the uppermost surface of each is the same; so that a helicopter (1) moved from the rollers (94) to the platform rollers (98) or vice-versa moves in a plane essentially parallel to the ground.

As a modification to the seventh embodiment one or more of the platform rollers (98) on each platform channel (96,97) is driven by a motor (99). The surface of each driven platform roller (98) includes a helical surface feature (not shown) that runs parallel to the rotational axis. By activating one or more of these driven platform rollers (98) the helicopter skid (100) resting on it can be moved along the length of that platform roller (98). By controlling the direction and speed of each motor (99) the helicopter (1) can be moved sideways, rotated or slewed on the mobile platform (2).

In a further embodiment the first face (11) has one or more self luminescent patterns (101) applied to its surface, such that the or each self luminescent patterns adapted to provide a self illuminated graphical representation of the orientation of the platform (1) to the user (32) inside a helicopter (1) landing on the mobile platform (2) at night.

In a further embodiment the or each drive unit includes traction control on the or each drive wheel, said traction control is of a known type.

It should be noted that the load unit and load cells could be fitted to a fixed helicopter pad and used to determine the weight and balance of a helicopter on that pad.

In a further embodiment the transmitter (31) is adapted to send a further wireless signal to a hangar door controller (not shown). The hangar door controller is connected to control equipment adapted to open and close the hangar door (not shown).

In a further embodiment the control unit (33) or transmitter (31) includes presets so that one activation causes the platform to undertake a preset series of movements e.g. one of the presets moves the mobile platform (2) from its storage position in the hangar to a predetermined location on the apron, which can include opening the hangar door automatically.

In a further embodiment (not shown) the platform (2) uses a GPS (global positioning system) device to navigate to a preset location taking into account pre mapped obstacles. This embodiment may include an obstacle avoidance system to allow it to avoid unmapped obstacles, such as recently parked aircraft.

In a further embodiment (not shown) the platform (2) includes latches adapted to lock the helicopter to the platform (2). The latches are manual or controlled by the control unit (33).

The user (32) can control the platform (2) wirelessly using the transmitter (31) from inside the cockpit (40), alongside the platform (2) or from a remote location. The remote location may not be within visual range of the platform (2) but the user (32) in this case has access to a visual display unit that is configured to provide a graphical representation of the platform (2) and its location/environment. The visual display unit can be built into the transmitter (31) though it can be remote from this.

Any discussion of the prior art throughout the specification is not an admission that such prior art is widely known or forms part of the common general knowledge in the field.

1. A self-powered mobile platform that is configured to be remotely wirelessly controlled, said platform including a base with a first face that is dimensioned and configured to allow a vertical landing aircraft to land and take off.

2. The mobile platform as claimed in claim 1 characterised in that the first face is a rectangular planar surface.

3. The mobile platform as claimed in claim 1 characterised in that aircraft is a helicopter.

4. The mobile platform as claimed in claim 1 characterised in that said mobile platform is configured to be controlled by a person inside the aircraft.

5. The mobile platform as claimed in claim 1 characterised in that the base includes movement means adapted to move the platform across the ground.

6. The mobile platform as claimed in claim 5 characterised in that said movement means are one or more pairs of drive units, the or each pair of drive units extending from or through a second face which is opposite the first face.

7. The mobile platform as claimed in claim 6 characterised in that the or each pair of drive units is configured to swivel about an axis perpendicular to the first face.

8. The mobile platform as claimed in claim 6 characterised in that drive units are selected from the list consisting of: wheels, groups of wheels and short self laying tracks.

9. The mobile platform as claimed in claim 5 characterised in that said movement means are two or more independently driven omni-directional wheels, each omni directional wheel extending from or through a second face which is opposite the first face.

10. The mobile platform as claimed in claim 9 characterised in that there are four omnidirectional wheels.

11. The mobile platform as claimed in claim 6 characterised in that each drive unit is driveable by a drive motive device.

12. The mobile platform as claimed in claim 9 characterised in that each omni-directional wheel is driveable by an OD motive device.

13. The mobile platform as claimed in claim 11 or 12 characterised in that each motive device is selected from the list consisting of: an electric motor, a hydraulic motor and an air driven motor.

14. The mobile platform as claimed in claimed in claim 11 or 12 characterised in that the platform includes a receiver configured to receive a wireless signal and a control unit configured to individually control the or each motive device, such that in use the wireless signal received by the receiver is passed to the control unit in a form which it understands.

15. The mobile platform as claimed in claim 14 characterised in that the receiver and control unit are a single device.

16. The mobile platform as claimed in claim 14 characterised in that the control unit includes stored preset movement patterns, such that in use a single wireless signal causes a preset pattern of movements to be undertaken by the platform.

17. The mobile platform as claimed in claim 16 characterised in that one of the preset patterns of movements causes the platform to return to its storage location.

18. The mobile platform as claimed in claim 16 characterised in that the stored preset movement patterns can be modified by input from one or more external devices.

19. The mobile platform as claimed in claim 18 characterised in that the external device is selected from the list consisting of: a Global Positioning System (GPS) and an obstacle avoidance unit.

20. The mobile platform as claimed in claim 14 characterised in that the control unit is configured to receive a weather signal from a weather station.

21. The mobile platform as claimed in claim 20 characterised in that the control unit is configured to adjust the position of the platform based on that weather signal by activating one or more of the motive devices.

22. The mobile platform as claimed in claim 21 characterised in that the control unit is adapted to adjust the position of the platform into the wind.

23. The mobile platform as claimed in claim 20 characterised in that the control unit is configured to receive information from a Global Positioning System (GPS) device and combine this with the weather signal from the weather station to adjust the position of the platform.

24. The mobile platform as claimed in claim 20 characterised in that the weather signal includes one or more piece of information selected from the list consisting of: wind velocity, wind direction, barometric pressure, temperature and humidity.

25. The mobile platform as claimed in claim 1 characterised in that the first face includes at least two landing strips, such that each strip is dimensioned and configured to accommodate one skid or wheel of the aircraft on the platform.

26. The mobile platform as claimed in claim 1 characterised in that the platform includes a load unit and at least one load measuring device.

27. The mobile platform as claimed in claim 26 characterised in that the or each landing strip includes at least one load measuring device, such that the or each said load measuring device is configured to measure the load on all or part of the associated landing strip and generate a measured load signal then transmit this to the load unit.

28. The mobile platform as claimed in claim 27 characterised in that the load unit combines the or each measured load signal and calculates a landing strip load signal related to the associated landing strip.

29. The mobile platform as claimed in claim 28 characterised in that the load unit is configured to further process the landing strip load signals to create an aircraft load signal representative of the weight and balance of the aircraft on the platform.

30. The mobile platform as claimed in claim 26 characterised in that the load unit is configured to combine the measured load signal from the or each load measuring device to create a platform load signal.

31. The mobile platform as claimed in claim 30 characterised in that the load unit is configured to further process the platform load signal to create an aircraft load signal representative of the weight and balance of the aircraft on the platform.

32. The mobile platform as claimed in claim 28 characterised in that in use the or each load signal is transmitted to a visual display unit which is configured to graphically display the load signal and/or the weight and balance of the platform or aircraft.

33. The mobile platform as claimed in claim 32 characterised in that in use the or each load signal is continuously updated and transmitted.

34. The mobile platform as claimed in claim 53, characterised in that in use the weather signal is combined with aircraft information and one or more of the load signals to calculate a maximum hover altitude for the aircraft.

35. The mobile platform as claimed in claim 26 characterised in that the load measuring device is a load cell.

36. The mobile platform as claimed in claim 14 characterised in that the platform includes a moving device, such that said moving device is configured to adjust the position and orientation of the aircraft on the platform without moving the platform.

37. The mobile platform as claimed in claim 36 characterised in that the moving device is configured to be controlled by a control signal from the load unit or control unit.

38. The mobile platform as claimed in claim 37, characterised in that the control unit or load unit is configured to use a load signal from the or each load measuring device and the weight and balance data for the aircraft to create the control signal.

39. The mobile platform as claimed in claim 38 characterised in that in use the weight and balance data for the aircraft is received from a transponder in the aircraft that is configured to store and transmit aircraft data; said aircraft data is data relating to the aircraft.

40. The mobile platform as claimed in claim 1 characterised in that the first face includes self illuminating patterns.

41. The mobile platform as claimed in claim 40 characterised in that the self illuminating patterns are self luminescent.

42. The mobile platform as claimed in claim 40 characterised in that the patterns provide a graphical representation of the orientation of the platform.

43. The mobile platform as claimed in claim 40 characterised in that the patterns are visible to a user in the aircraft landing on the mobile platform at night.

44. A storage system for storing a vertical landing aircraft with skids, said storage system includes a mobile platform as claimed in claim 25 with two landing strips and one or more storage bays; each landing strip includes a platform channel that extends lengthwise to at least one end of the first face, each said platform channel includes a plurality of platform rollers, said storage bay includes a pair of bay channels that include a plurality of bay rollers, each channel is a u-shaped channel and each platform roller is a cylindrical roller with it's rotational axis perpendicular to the length of the associated channel, such that the rollers are configured to support the aircraft on the platform or stored in the bay.

45. A storage system as claimed in claim 44 characterised in that at least one platform roller in each platform channel is independently driveable by a platform motive device.

46. A storage system as claimed in claim 45 characterised in that each platform motive device is independently chosen from the group consisting of: an electric motor, a hydraulic motor and a pneumatic motor.

47. A storage system as claimed in any one of claims 44 characterised in that at least one bay roller is driveable by a bay motive device.

48. A storage system as claimed in claim 47 characterised in that each said bay motive device is independently chosen from the group consisting of: an electric motor, a hydraulic motor and a pneumatic motor.

49. A storage system as claimed in claim 45 characterised in that the two or more driven platform rollers form part of a moving device, such that said moving device is configured to adjust the position and orientation of the aircraft on the platform without moving the platform.

50. A method for storing aircraft using the storage system as claimed in any one of claims 44 that includes the following steps, in order:
i. The aircraft lands on the mobile platform with each skid supported by the platform rollers of a separate platform channel;
ii. The alignment of the aircraft is adjusted so that its longitudinal axis is parallel to the longitudinal axis of the platform channels;
iii. The mobile platform transports the aircraft to the storage bay desired;
iv. The position of the mobile platform is adjusted so that the longitudinal axis of each platform channel aligns with the longitudinal axis of a matching bay channel of the storage bay;
v. The mobile platform is moved towards the storage bay until each bay channel and the matching platform channel form a single continuous path for the aircraft to follow;
vi. The aircraft is then moved along the platform rollers and onto the bay rollers, until the aircraft is properly stowed in the storage bay.

51. The mobile platform as claimed in claim 20 characterised in that the control unit is configured to receive information from a Global Positioning System (GPS) device and combine this with the weather signal from the weather station to adjust the position of the platform into the wind.

52. The mobile platform as claimed in claim 21 characterised in that the first face includes at least two landing strips, such that each strip is dimensioned and configured to accommodate one skid or wheel of the aircraft on the platform.

53. The mobile platform as claimed in claim 14 characterised in that the platform includes a load unit and at least one load measuring device.

54. The mobile platform as claimed in claim 53 characterised in that the or each landing strip includes at least one load measuring device, such that the or each said load measuring device is configured to measure the load on all or part of the associated landing strip and generate a measured load signal then transmit this to the load unit.

55. The mobile platform as claimed in claim 54 characterised in that the load unit combines the or each measured load signal and calculates a landing strip load signal related to the associated landing strip.

56. The mobile platform as claimed in claim 55 characterised in that the load unit is configured to further process the landing strip load signals to create an aircraft load signal representative of the weight and balance of the aircraft on the platform.

57. The mobile platform as claimed in claim 53 characterised in that the load unit is configured to combine the measured load signal from the or each load measuring device to create a platform load signal.

58. The mobile platform as claimed in claim 57 characterised in that the load unit is configured to further process the platform load signal to create an aircraft load signal representative of the weight and balance of the aircraft on the platform.

59. The mobile platform as claimed in claim 29 characterised in that in use the or each load signal is transmitted to a visual display unit which is configured to graphically display the load signal and/or the weight and balance of the platform or aircraft.

60. The mobile platform as claimed in claim 31 characterised in that in use the or each load signal is transmitted to a visual display unit which is configured to graphically display the load signal and/or the weight and balance of the platform or aircraft.

61. The mobile platform as claimed in claim 53 characterised in that the load measuring device is a load cell.

62. The mobile platform as claimed in claim 14 characterised in that the platform includes a moving device, such that said moving device is configured to adjust the position and orientation of the aircraft on the platform without moving the platform.

63. The mobile platform as claimed in claim 62 characterised in that the platform includes a load unit and at least one load measuring device.

64. The mobile platform as claimed in claim 63 characterised in that the moving device is configured to be controlled by a control signal from the load unit or control unit.

65. The mobile platform as claimed in claim 64, characterised in that the control unit or load unit is configured to use a load signal from the or each load measuring device and the weight and balance data for the aircraft to create the control signal.

66. The mobile platform as claimed in claim 64 characterised in that in use the weight and balance data for the aircraft is received from a transponder in the aircraft that is configured to store and transmit aircraft data; said aircraft data is data relating to the aircraft.
